(19) United States
(12) Patent Application Publication
(10) Pub. No.: US 2025/0034418 A1
(43) Pub. Date: Jan. 30, 2025

(54) Recording Apparatus, Method Of Recording, And Ink Coposition

(71) Applicant: SEIKO EPSON CORPORATION, Tokyo (JP)

(72) Inventor: Sena GOZU, Shiojiri (JP)

(21) Appl. No.: 18/785,033

(22) Filed: Jul. 26, 2024

(30) Foreign Application Priority Data
Jul. 28, 2023 (JP) 2023-123306

(51) Int. Cl. C09D 11/38; B41J 2/175; C09D 11/322; C09D 11/40

(52) U.S. Cl. CPC C09D 11/38; B41J 2/17506; B41J 2/17566; C09D 11/322; C09D 11/40

(57) ABSTRACT

A recording apparatus having an ink storage body, an ink supply section, an ink jet head, and an ink composition, wherein the ink storage body has an ink pouring port through which the ink composition is poured and a liquid level display section displaying an ink liquid level of the ink composition stored in the ink storage body, the ink jet head is supplied with the ink composition from the ink storage body via the ink supply section and ejects the ink composition to cause the ink composition to adhere to a recording medium, and the ink composition is a water-based, red-based ink containing an azo-based pigment, an acetylene glycol-based surfactant A with an HLB value of less than 10 and an acetylene glycol-based surfactant B with an HLB value of 10 or more.

The present application is based on, and claims priority from JP Application Serial Number 2023-123306, filed Jul. 28, 2023, the disclosure of which is hereby incorporated by reference herein in its entirety.

### BACKGROUND

### 1. Technical Field

The present disclosure relates to a recording apparatus, a method of recording, and an ink composition.

### 2. Related Art

Ink jet recording apparatuses are known that record images or like on recording media with minute ink droplets ejected from nozzles of recording heads for ink jet recording.

Remote working and SOHO are increasing, and opportunities of using ink jet recording apparatuses in homes or the like are increasing.

An ink jet recording apparatus has an ink container (for example, an ink cartridge) for supplying an ink composition to a recording head.

Examples of such an ink container include a type in which the ink container itself is replaced when the ink composition in the ink container becomes a certain amount or less (what is called an ink cartridge) and a type in which the ink composition is refilled in a continuous supply type ink container without replacing the ink container (what is called a continuous supply type ink container).

For example, JP-A-2015-061896 describes an ink composition to be filled in an ink container having an ink chamber that can be refilled with an ink composition and an openable and closable ink pouring port, in which the ink chamber can communicate with outside air, the ink composition containing a pigment, a resin, and an organic solvent, and having a static contact angle with a member constituting the inside of a wall sectioning the ink chamber of 10° or more.

Examples of an ink storage body include the continuous supply type ink container described above (in the present specification, also referred to as a CISS tank). The CISS tank has an advantage in that continuous printing is enabled without time and effort to replace the ink cartridge. In addition, an ink cartridge is not required for each replacement, and all that is required is only ink is refilled in the ink storage body.

However, the CISS tank can have a liquid level display section for checking an ink remaining amount, but the visibility of the liquid level display section may be impaired by the ink adhering to a wall face.

Meanwhile, for example, when the ink is filled in a printer for the first time, air bubbles may be mixed in an ink jet head to impair filling properties.

The present inventors have earnestly studied in order to solve the above problems. Consequently, it has been found that the above problems can be solved by using an ink jet recording apparatus including a certain configuration to complete the present disclosure.

### SUMMARY

The present disclosure is as follows.

A recording apparatus of the present disclosure is a recording apparatus having an ink storage body, an ink supply section, an ink jet head, and an ink composition, wherein the ink storage body has an ink pouring port through which the ink composition is poured and a liquid level display section displaying an ink liquid level of the ink composition stored in the ink storage body, the ink jet head is supplied with the ink composition from the ink storage body via the ink supply section and ejects the ink composition to cause the ink composition to adhere to a recording medium, and the ink composition is a water-based, red-based ink containing an azo-based pigment, an acetylene glycol-based surfactant A with an HLB value of less than 10 and an acetylene glycol-based surfactant B with an HLB value of 10 or more.

A method of recording of the present disclosure is a method of recording performed using a recording apparatus having an ink storage body, an ink supply section, and an ink jet head, the method having a supplying step of supplying an ink composition to the ink jet head from the ink storage body via the ink supply section, and an adhering step of ejecting the ink composition from the ink jet head to cause the ink composition to adhere to a recording medium, wherein the ink storage body has an ink pouring port through which the ink composition is poured and a liquid level display section displaying an ink liquid level of the ink composition stored in the ink storage body, and the ink composition is a water-based, red-based ink containing an azo-based pigment, an acetylene glycol-based surfactant A with an HLB value of less than 10 and an acetylene glycol-based surfactant B with an HLB value of 10 or more.

An ink composition of the present disclosure is an ink composition for use in recording by a recording apparatus having an ink storage body, an ink supply section, and an ink jet head, wherein the ink storage body has an ink pouring port through which the ink composition is poured and a liquid level display section displaying an ink liquid level of the ink composition stored in the ink storage body, the ink jet head is supplied with the ink composition from the ink storage body via the ink supply section and ejects the ink composition to cause the ink composition to adhere to a recording medium, and the ink composition is a water-based, red-based ink containing an azo-based pigment, an acetylene glycol-based surfactant A with an HLB value of less than 10 and an acetylene glycol-based surfactant B with an HLB value of 10 or more.

### BRIEF DESCRIPTION OF THE DRAWINGS

FIG. 1 is a table showing results of examples.

FIG. 2 is a table showing results of examples and comparative examples.

FIG. 3 is a table showing results of comparative examples.

FIG. 4 is a schematic diagram of an example of an ink jet recording apparatus of the present embodiment.

FIG. 5 is a schematic diagram of another example of the ink jet recording apparatus of the present embodiment.

### DESCRIPTION OF EMBODIMENTS

The following describes an embodiment of the present disclosure (hereinafter referred to as the “present embodiment”) in detail. The present disclosure is not limited to this embodiment, and various modification can be made without departing from the gist thereof.

### 1. Recording Apparatus

A recording apparatus of the present embodiment is a recording apparatus having an ink storage body, an ink supply section, an ink jet head, and an ink composition, in which the ink storage body has an ink pouring port through which the ink composition is poured and a liquid level display section displaying an ink liquid level of the ink composition stored in the ink storage body, the ink supply section supplies the ink composition to the ink jet head from the ink storage body, the ink jet head is supplied with the ink composition from the ink storage body via the ink supply section and ejects the ink composition to cause the ink composition to adhere to a recording medium, and the ink composition is a water-based, red-based ink containing an azo-based pigment, an acetylene glycol-based surfactant A with an HLB value of less than 10 and an acetylene glycol-based surfactant B with an HLB value of 10 or more.

As red-based inks such as magenta inks, inks containing quinacridone pigments haven been known. However, inks containing quinacridone pigments may be insufficient in color developing properties and the visibility of an ink liquid level. Given these circumstances, the present inventors have thought that the visibility of an ink liquid level can be improved by employing a red-based ink containing an azo-based pigment (red-based) having good color developing properties.

However, it has been found that the red-based ink containing an azo-based pigment (red-based) has good color developing properties, and thus once the ink adheres to an inner wall face of a liquid level display section, the ink hinders the ink liquid level from being visually checked, contrarily making it difficult to visually check the liquid level.

When the ink is poured into the ink storage body, the ink may adhere to an inner wall face of the ink storage body. This is because, for example, the ink splashes or foaming occurs during pouring. In addition, the ink adheres to the inner wall face of the liquid level display section due to shaking of the ink storage body or the like. In addition, when the ink is consumed, and the liquid level is lowered, the ink adhering to the inner wall face of the liquid level display section remains.

In such cases, when the ink has excellent running down properties, the ink quickly runs down from the inner wall face of the liquid level display section and does not adhere thereto. However, when the ink has poor running down properties, the rate of the ink running down from the inner wall face of the liquid level display section is low, and ink adhesion remains.

Furthermore, when the running down rate of the ink is low, the ink dries before the ink runs down and has lowered flowability, making it more difficult for the ink to run down. Consequently, the visibility of an ink liquid level in the liquid level display section decreases.

The recording apparatus of the present embodiment, including the configuration described above, is excellent in the visibility of an ink liquid level and initial filling properties.

### 1.1. Ink Storage Body

The recording apparatus of the present embodiment has the ink storage body.

The ink storage body has an ink pouring port through which the ink composition is poured and the liquid level display section displaying the ink liquid level of the ink composition stored in the ink storage body.

The ink storage body in the present embodiment is not limited in its form unless otherwise specifically noted.

For example, in ink storage bodies for respective colors (for example, CISS tanks), their heights from the ink pouring port to the bottom may vary depending on the design or layout of the ink storage bodies. For example, the ink storage body may have a large height from the ink pouring port to the bottom. For example, when ink storage bodies are stacked in two layers in order to make the lateral length of a printer compact, the ink storage body the height of two normal ink storage bodies may be provided.

Alternatively, when the ink storage body having a large volume, the lateral width of the ink storage body may be increased. When the lateral width of the ink storage body is not desired to be increased from the viewpoint of layout, the height of the ink storage body may be increased. In that case, the CISS tanks for the respective colors may have different heights from the filling port to the tank bottom.

Alternatively, the CISS tanks for the respective colors may have a free layout so as to have the same volume but different heights.

The ink pouring port is a port through which the ink composition is poured in order to fill the ink composition into the ink storage body.

The ink composition poured through the ink pouring port is stored in the ink storage body. When the ink composition is stored in the ink storage body, the ink liquid level can be visually checked from the liquid level display section.

The liquid level display section displays the ink liquid level of the ink composition stored in the ink storage body. This enables the remaining amount of the ink composition to be checked.

The liquid level display section is included in the ink storage body, and thus the material of the liquid level display section and the material of the ink storage body may be the same. The materials of the liquid level display section and the ink storage body are the materials of the parts in contact with ink thereinside.

The material of the liquid level display section, which is not particularly limited, is preferably a thermoplastic resin. It is preferably polyolefin, and the material of the inner wall face of the liquid level display section is more preferably polypropylene.

The liquid level display section, which is not particularly limited, may be, for example, transparent or semitransparent resin, glass, or the like. Owing to the liquid level display section, a user can visually check the liquid level of the ink composition stored in the ink storage body from outside the ink storage body.

The ink storage body has a volume of preferably 10 cm³ to 500 cm³, preferably 40 cm³ to 400 cm³, and preferably 80 cm³ to 300 cm³ from the viewpoint of preventing foaming to improve initial filling properties.

The ink storage body may specifically have the following aspect.

The ink storage body supplies the ink composition to the ink jet head via the ink supply section. The ink storage body may have the ink pouring port provide in the upper part and a liquid storage part communicating with the ink pouring port and outside air. The user inserts a refilling port of an ink bottle into the ink pouring port of the ink storage body and can thereby pour the ink stored in the ink bottle into the ink storage body. That is, the ink storage body is preferably an ink storage body of what is called the continuous supply type, into which ink is refilled from outside without replacing the ink storage body even when the ink stored in the ink storage body runs out. The problem of the foaming of the ink composition often occurs especially when the ink is refilled, and thus the ink jet recording apparatus of the present embodiment preferably has the ink storage body of what is called the continuous supply type, which enables ink refilling.

Such a continuous supply type ink storage body having the ink pouring port through which the ink composition is poured and capable of continuously supply the ink to the ink jet head is called a CISS tank.

Ink jet printers including such a continuous supply type ink storage body, which enables ink refilling, may be used for printing characters and images on plain paper in offices and SOHO.

### 1.2. Ink Supply Section

The recording apparatus of the present embodiment has the ink supply section.

The ink supply section supplies the ink composition to the ink jet head from the ink storage body. Specifically, the ink supply section is, for example, an ink supply tube, an ink tube, or the like and is a component circulating ink from the ink storage body to the ink jet head to supply the ink to the ink jet head from the ink storage body.

The ink storage body and the ink jet head are connected to each other via the ink supply section.

In ink circulation, the ink may be circulated through negative pressure caused by ejecting the ink from the ink jet head, a height difference, or the like, or a liquid feeding mechanism or the like such as a pump may be used.

### 1.3. Ink Jet Head

The recording apparatus of the present embodiment has the ink jet head.

The ink jet head receives supply of the ink composition from the ink storage body via the ink supply section and ejects the ink composition to cause the ink composition to adhere to the recording medium.

The ink jet head may have a nozzle face provided at a position facing a recording face of the recording medium and eject the ink formed into a droplet shape from a plurality of nozzles provided on the nozzle face to cause the ink to adhere to the recording face of the recording medium.

The ink jet head may be a line head or a serial head.

In the line method using the line head, with a head fixed, the recording medium is moved along a sub-scanning direction (the longitudinal direction or the transportation direction of the recording medium), and ink droplets are ejected from a nozzle opening of the head in sync with this movement, thereby recording images on the recording medium. A line printer as an ink jet recording apparatus of the line method includes the line head with a length that is the length corresponding to the width of the recording medium or more as the head.

On the other hand, in the serial method using the serial head, the head is moved along a main scanning direction (the lateral direction or the width direction of the recording medium), and ink droplets are ejected from a nozzle opening of the head in sync with this movement, thereby recording images on the recording medium. A serial printer as an ink jet recording apparatus of the serial type performs main scanning (pass) in which the head ejects the ink composition while moving in the main scanning direction crossing the sub-scanning direction of the recording medium and normally performs recording on two passes or more (multi-pass).

The ink jet head has a cavity ejecting the stored ink composition from a nozzle, an ejection drive part applying driving force for ejection to the ink composition, provided for each cavity, and the nozzle ejecting the ink composition to outside the ink jet head, provided for each cavity. As to the cavity and the ejection drive part and the nozzle provided for each cavity, a plurality of cavities, ejection drive parts, and nozzles may be provided in one head in a mutually independent manner. The ejection drive part can be formed using an electric-mechanical conversion element such as piezoelectric element changing the volume of the cavity through mechanical deformation, an electron-thermal conversion element producing air bubbles in the ink by generating heat and ejecting the ink, or the like.

The ink jet recording apparatus may be provided with one head or a plurality of heads for an ink of one color.

### 1.4. Ink Composition

The ink jet recording apparatus of the present embodiment has the ink composition (also referred to simply as “ink”).

At least one of the ink compositions is a water-based, red-based ink containing an azo-based pigment, an acetylene glycol-based surfactant A with an HLB value of less than 10, and an acetylene glycol-based surfactant B with an HLB value of 10 or more.

The ink compositions of the present embodiment may be designed so as to fulfill required characteristics based on the structures and properties of the recording apparatus, the ink storage body, and the like.

The following describes components contained in the ink composition (hereinafter also referred to simply as “ink”) of the present embodiment.

### 1.4.1. Azo-Based Pigment

The ink composition of the present embodiment contains the azo-based pigment. Examples of the azo-based pigment include monoazo pigments, disazo pigments, condensed disazo pigments, and benzimidazolone pigments.

Among the azo-based pigments, a pigment capable of coloring a red-based color is used.

For example, a pigment being the azo-based pigment and capable of establishing the ink composition as a red-based ink can be used. Examples include pigments being the azo-based pigment and given numbers of C.I. Pigment Red.

Specific examples of such azo-based pigments include C.I. Pigment Red 5, C.I. Pigment Red 17, C.I. Pigment 22, C.I. Pigment Red 31, C.I. Pigment Red 48:1, C.I. Pigment Red 48:2, C.I. Pigment Red 53:1, C.I. Pigment Red 57:1, C.I. Pigment Red 146, C.I. Pigment Red 150, C.I. Pigment Red 185, C.I. Pigment Red 114, C.I. Pigment Red 146, C.I. Pigment Red 150, C.I. Pigment Red 170, C.I. Pigment Red 184, C.I. Pigment Red 185, C.I. Pigment Red 208, C.I. Pigment Red 245, C.I. Pigment Red 268, C.I. Pigment Red 269, and solid solutions of these.

Among the above, from the viewpoint of being capable of obtaining images with better color developing properties, the azo-based pigment is preferably one or more selected from the group consisting of C.I. Pigment Red 150, C.I. Pigment Red 269, and C.I. Pigment Red 17.

In addition, from the viewpoint of being capable of obtaining images with even better color developing properties, the azo-based pigment is preferably a compound represented by Formula (I) below and a solid solution thereof:

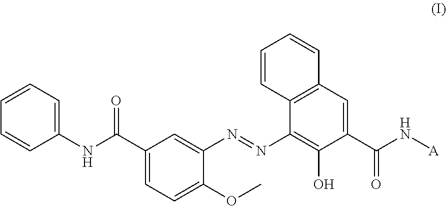

where in Formula (I), A represents a hydrogen atom or an aromatic group.

The aromatic group is a group having an aromatic ring such as a benzene ring or a naphthalene ring, in which the aromatic ring can be substituted or unsubstituted. The aromatic ring directly bonds to the nitrogen atom to which the aromatic group bonds. Furthermore, when the aromatic ring has a substituent, the substituent is not particularly limited and is, for example, an organic group or an inorganic group. The number of substituents can be selected freely. The substituent is not limited, and examples thereof include an alkyl group, a halo group, an alkoxy group, a hydroxy group, a carboxy group, an amino group, and a nitro group.

The azo-based pigment may be a resin-dispersed pigment dispersed with resin or a self-dispersed pigment with the pigment surface treated and functional groups introduced; the resin-dispersed pigment is preferred.

The volume average particle size D50 of the azo-based pigment is preferably 110 nm or less. The volume average particle size D50 of the azo-based pigment can be measured with a particle size distribution measurement apparatus. Examples of the particle size distribution measurement apparatus include particle size distribution meters with dynamic light scattering as their measurement principle (for example, “Nanotrac Series” manufactured by MicrotracBEL Corporation). The volume average particle size is a D50 value.

The volume average particle size of the azo-based pigment is preferably 10 nm or more and 110 nm or less, more preferably 50 nm or more and 110 nm or less, even more preferably 80 nm or more and 110 nm or less, still even more preferably 80 nm or more and less than 110 nm, and particularly preferably 80 nm or more and 100 nm or less.

By making the volume average particle size of the azo-based pigment within the above range, the pigment has good dispersion stability and better color developing properties, and the precipitation of the component during storage is more prevented.

The volume average particle size of the azo-based pigment may be adjusted by, for example, adjusting the degree of pulverization, such as the strength of pulverization or a pulverization time, in a pulverization step of pulverizing pigment particles. The volume average particle size of the azo-based pigment may also be adjusted by adjusting the strength of stirring or a stirring time in a dispersion step of dispersing the pigment particles in a dispersion liquid. The particle size of the pigment may also be adjusted by performing classification with a filter after pulverization or dispersion.

The ink composition of the present embodiment can be an ink having excellent color developing properties by containing the azo-based pigment described above. Thus, the adhesion amount of the ink to obtain excellent color developing properties can be made small. Thus, the ink is less consumed, showing a tendency that the ink remains stored in the ink storage body for a long term. Even in such a case, by making the volume average particle size of the azo-based pigment within the above range, the pigment has good dispersion stability and better color developing properties, and the precipitation of the component during storage is more prevented.

The content of the azo-based pigment is preferably 1.0% by mass to 8.0% by mass, more preferably 3.0% by mass or more and 7.5% by mass, and even more preferably 4.0% by mass to 7.0% by mass with respect to the total amount of the ink composition.

By the content of the azo-based pigment being within this range, images with even better color developing properties can be obtained.

The ink composition may contain pigments other than the azo-based pigment.

The content of the pigments other than the azo-based pigment is preferably 70% by mass or more, 80% by mass to 100% by mass, and 90% by mass to 100% by mass.

The ink composition of the present embodiment is a water-based, red-based ink. The red-based ink is an ink mainly used to represent red when printing reproducing secondary or more colors using inks of a plurality of colors is performed. Examples thereof include magenta inks, red inks, and inks similar to these.

The red-based ink is preferably a magenta ink. The magenta ink here means an ink that is normally used as an ink set together with a cyan ink, a yellow ink, and as needed, a black ink. Examples thereof include inks generally named the magenta ink and inks as a whole that remind of being the magenta ink in commercially available ink cartridges.

The red refers to a color the hue angle of which is within a certain range in the L*a*b color system normalized by Commission Internationale de l'Eclairage (CIE). The hue angle of the red is preferably 5° or more and 60° or less, 15° or more and 50° or less, and 25° or more and 40° or less.

The red-based ink is an ink mainly used when the red is printed.

The red-based ink is preferably an ink that can represent the red by itself.

The recording apparatus of the present embodiment can further use inks other than the ink composition.

The recording apparatus of the present embodiment preferably further has a cyan ink, a yellow ink, and a black ink. In this case, the recording apparatus of the present embodiment preferably has an ink jet head C ejecting the cyan ink, an ink jet head Y ejecting the yellow ink, and an ink jet head B ejecting the black ink.

The cyan ink, the yellow ink, and the black ink contain colorants having color developing properties of cyan, yellow, and black, respectively, as colorants.

### 1.4.2. Surfactant

The ink in the present embodiment contains the acetylene glycol-based surfactant A with an HLB value of less than 10 and the acetylene glycol-based surfactant B with an HLB value of 10 or more. The surfactant has the function of reducing surface tension and improving wettability with the recording medium. In the present specification, the “HLB value” refers to a value defined by the Griffin method.

By containing the acetylene glycol-based surfactant A, ink initial filling properties to the recording apparatus more improves. If air bubbles remain in an ink flow path or members inside the head during ink initial filling (first-time filling or filling to an empty state), faulty ejection of the ink composition occurs due to the air bubbles. The low-HLB acetylene glycol-based surfactant increases ink the wettability of the ink to the ink flow path or the members inside the head and prevents air bubbles from remaining, thus preventing the faulty ejection of the ink composition (initial filling properties).

Meanwhile, the wettability of the ink to the members thereby increases, and when the ink adheres to a tank wall face, the ink may poorly run down, which may hinder the visibility of a liquid level. In addition, the acetylene glycol-based surfactant A increases the foaming properties of the ink, which easily foams. With this, foaming easily occurs during ink filling to the tank, which causes an ink spill from the tank. In addition, foam causes the ink to adhere to the tank wall face.

Given these circumstances, in the present embodiment, the acetylene glycol-based surfactant B is further used in addition to the acetylene glycol-based surfactant A. With this, ink running down from the tank wall face improves, and the liquid level visibility further improves. In addition, the acetylene glycol-based surfactant B prevents ink wettability, improves ink running down, and more improves visibility. In addition, the acetylene glycol-based surfactant B prevents ink foaming. Examples of the acetylene glycol-based surfactant include an acetylene glycol-based surfactant represented by Formula (1) below:

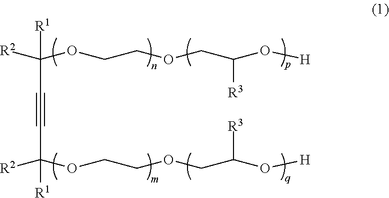

where in Formula (1), R¹, R², and R³ each independently represent an alkyl group having one to six carbon atoms; m, n, p, and q are each independently an integer of 0 to 50.

R¹, R², and R³ are not particularly limited, and examples thereof include methyl, ethyl, n-propyl, iso-propyl, n-butyl, sec-butyl, and tert-butyl. R³ is preferably a methyl group.

Examples of the acetylene glycol-based surfactant A include the acetylene glycol-based surfactant represented by Formula (1), and preferable examples include one with n+p and m+q being independently 0 to 30 in Formula (1). Furthermore, n+p and m+q are each independently preferably 15 or less, more preferably 10 or less, and particularly preferably 5 or less.

Furthermore, in Formula (1), one with n+p+m+q being 0 to 30 is preferred, being 15 or less is more preferred, being 10 or less is even more preferred, and being 5 or less is particularly preferred.

Furthermore, in Formula (1), the acetylene glycol-based surfactant with n, m, p, and q being each zero is more preferred.

Among these, preferable examples include polyoxyethylene (4) acetylenic glycol ether, 2,5,8,11-tetramethyl-6-dodecyne-5,8-diol, 2,4,7,9-tetramethyl-5-decyne-4,7-diol, and 2,4,7,9-tetramethyldec-5-yne-4,7-diol. By containing such a surfactant, there is a tendency that initial filling properties more improve.

The acetylene glycol-based surfactant B is preferably an alkylene oxide adduct of acetylene glycol.

Examples thereof include one with n+p and m+q being each independently 1 or more in Formula (1). Further examples include one with n+p and m+q being each independently 1 to 50 in Formula (1). Furthermore, n+p and m+q are each independently preferably 6 to 30, more preferably 11 to 30, and even more preferably 16 to 30.

Alternatively, in Formula (1), one with n+p+m+q being 1 to 50 is preferred, being 6 to 30 is more preferred, being 11 to 30 is even more preferred, and being 16 to 30 is particularly preferred.

In Formula (1), there is a tendency that a smaller addition number of alkylene oxide gives a smaller HLB value, whereas a larger addition number of alkylene oxide gives a larger HLB value. Thus, for example, in Formula (1), by adjusting the addition number of alkylene oxide, the HLB value of the acetylene glycol-based surfactant can be adjusted.

For example, n+p and m+q in Formula (1) of the acetylene glycol-based surfactant A may be made smaller than n+p and m+q in Formula (1) of the acetylene glycol-based surfactant B.

Commercially available products of the acetylene glycol-based surfactant are not particularly limited, and examples thereof include Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, and GA (the above are all product names manufactured by AirProducts and Chemicals. Inc.); Olfine B, Y, P, A, STG, SPC, E1004, E1010, PD-001, PD-002W, PD-003, PD-004, EXP. 4001, EXP. 4036, EXP. 4051, EXP. 4200, EXP. 4300, AF-103, AF-104, AK-02, SK-14, and AE-3 (the above are all product names manufactured by Nissin Chemical Co., Ltd.); and Acetylenol E00, E00P, E40, and E100 (the above are all product names manufactured by Kawaken Fine Chemicals Co., Ltd.).

From the above, the acetylene glycol-based surfactant A with an HLB value of less than 10 and the acetylene glycol-based surfactant B with an HLB value of 10 or more can be selected as appropriate.

The acetylene glycol-based surfactant A is preferably Surfynol 104 and Surfynol SE-F.

The acetylene glycol-based surfactant B is preferably Olfine E1010 and EXP. 4200.

The content of the acetylene glycol-based surfactant A is preferably 0.1% by mass to 0.8% by mass with respect to the total amount of the ink composition.

The content of the acetylene glycol-based surfactant B is preferably 0.1% by mass to 0.8% by mass with respect to the total amount of the ink composition.

By the contents of the acetylene glycol-based surfactants A and B being within the above ranges, there is a tendency that excellence is achieved in the visibility of an ink amount and initial filling properties.

From the above viewpoint, the contents of the acetylene glycol-based surfactants A and B are each more preferably 0.2% by mass to 0.75% by mass and even more preferably 0.3% by mass to 0.7% by mass with respect to the total amount of the ink composition.

The ratio of the content of the acetylene glycol-based surfactant B to the content of the acetylene glycol-based surfactant A is preferably 0.1 to 10, 0.3 to 5, 0.5 to 2, and 0.8 to 1.5

The HLB value of the acetylene glycol-based surfactant A is less than 10, preferably 7 or less, more preferably 6 or less, and even more preferably 5 or less. The lower limit thereof is 0 or more.

The HLB value of the acetylene glycol-based surfactant B is 10 or more, preferably 11 to 20, more preferably 12 to 17, and even more preferably 13 to 15.

### 1.4.3. Resin

The ink of the present embodiment may contain resins such as resin particles, fixing resins, water-soluble resins, and pigment dispersant resins.

The resin particles have the function of, for example, improving the adhesion of the ink that has adhered to the recording medium. The pigment dispersant resins have the function of, for example, improving the dispersability of the pigment described above.

As the resin, any type of resins such as a dissolved one and a particulate one such as an emulsion can be used. For example, when the resin is particulate (hereinafter also referred to as “resin particles”), the volume-based average particle size of the resin particles (hereinafter also referred to simply as “the average particle size of the resin particles”) is preferably 30 nm or more and 300 nm or less. It is more preferably 50 nm or more and 200 nm or less. By the average particle size of the resin particles being within the above range, there is a tendency that the fixability of the ink to the recording medium improves, or clogging of a filter or a recording head decreases.

The average particle size of the resin particles can be measured with a particle size distribution measurement apparatus with laser diffraction scattering as its measurement principle. As the particle size distribution measurement apparatus, for example, a particle size distribution meter with dynamic light scattering as its measurement principle (for example, “Microtrac UPA” manufactured by Nikkiso Co., Ltd.) can be used.

Examples of the resin particles include acrylic-based resins, fluorene-based resins, urethane-based resins, polyolefin-based resins, rosin-modified resins, terpene-based resins, polyester-based resins, polyamide-based resins, epoxy-based resins, vinyl chloride-based resins, vinyl chloride-vinyl acetate copolymers, and ethylene-vinyl acetate-based resins. These resin particles may be used singly, or two or more may be used in combination.

The acrylic-based resins may be styrene-acrylic-based resins.

As the resin particles, commercially available products may be used, and examples thereof include Superflex (registered trademark) 420 (polyurethan water dispersion manufactured by DKS Co. Ltd.) and X-436 (styrene-acrylic resin emulsion manufactured by Seiko PMC Corporation).

Examples of the pigment dispersant resins include polyvinyl alcohols, polyacrylic acids, acrylic acid-acrylonitrile copolymers, vinyl acetate-acrylate copolymers, acrylic acid-acrylate copolymers, styrene-acrylic acid copolymers, styrene-methacrylic acid copolymers, styrene-methacrylic acid-acrylate copolymers, styrene-α-methylstyrene-acrylic acid copolymers, styrene-α-methylstyrene-acrylic acid-acrylate copolymers, styrene-maleic acid copolymers, styrene-maleic anhydride copolymers, vinylnaphthalene-acrylic acid copolymers, vinylnaphthalene-maleic acid copolymers, vinyl acetate-maleate copolymers, vinyl acetate-crotonic acid copolymers, vinyl acetate-acrylic acid copolymers, and salts of these.

Among these, the acrylic-based resins are preferred. The acrylic-based resin is a generic name of polymers obtained by polymerizing at least an acrylic-based monomer such as acrylic acid, methacrylic acid, acrylate, or methacrylate as one component. Examples thereof include resins obtained from the acrylic-based monomer and copolymers of the acrylic-based monomer and other monomers. Examples thereof include acrylic-vinyl-based resins as copolymers of the acrylic-based monomer and a vinyl-based monomer, and examples thereof include copolymers with the vinyl-based monomer such as styrene. Examples thereof include styrene-acrylic-based resins.

Among these, preferred are copolymers of a monomer having a hydrophobic functional group and a monomer having a hydrophilic functional group and polymers of a monomer having both a hydrophobic functional group and a hydrophilic functional group. As to the form of the copolymers, any form of a random copolymer, a block copolymer, an alternating copolymer, and a graft copolymer can be used.

The content of the resin in terms of solid content is preferably less than 100 parts by mass, preferably 0.5 part by mass or more and 60 parts by mass or less, preferably 1.0 part by mass or more and 50 parts by mass or less, and preferably 2.0 parts by mass or more and 40 parts by mass or les with respect to 100 parts by mass of the pigment contained in the ink.

By the content of the resin being less than the content of the pigment, the film formation of the resin that has adhered to the recording medium is difficult to be hindered by the pigment, thus showing a tendency that the adhesion of the ink to the recording medium improves.

The total of the contents of the resin and the pigment is preferably 20% by mass or less in terms of solid content with respect to the total mass (100% by mass) of the ink. By the total amount being 20% by mass or less, the occurrence of aggregates in the ink can be reduced.

The total of the contents of the resin and the pigment is more preferably 2% by mass or more and 15% by mass or less, 3% by mass or more and 15% by mass or less, and 3% by mass or more and 11% by mass or less.

### 1.4.4. Organic Solvent

The ink of the present embodiment may contain an organic solvent. The organic solvent is preferably a water-soluble organic solvent.

Examples of the organic solvent include alkanediols, polyhydric alcohols, glycol ethers, nitrogen-containing heterocyclic compounds, urea, and urea derivative. These may be used singly, or two or more may be used mixed together.

Examples of the alkanediols include 1,2-alkanediols having four to eight carbon atoms (for example, 1,2-butanediol, 1,2-pentanediol, 1,2-hexanediol, 1,2-octanediol, and the like), 2-methyl-1,3-propanediol, 2,2-dimethyl-1,3-propanediol, and 2-ethyl-1,3-hexanediol.

The alkanediols have the functions of, for example, improving wettability to the recording medium and preventing drying and solidification of the ink on the nozzle face of the recording head. In addition, ink running down properties can also be improved, thus providing better liquid level visibility, which is preferred.

When the alkanediols are contained, from the viewpoint of preventing wettability from increasing too much, their content is preferably 0.1% by mass or more and 20% by mass or less, more preferably 0.5% by mass or more and 15% by mass or less, even more preferably 0.7% by mass or more and 10% by mass or less, and particularly preferably 1.0% by mass or more and 4.0% by mass or less with respect to the total amount of the ink composition.

Among the alkanediols, 1,2-alkanediols having five or six carbon atoms are preferably used. This is because these compounds provide less reduction in the surface tension of the ink even though they improve the penetrability and wettability of the ink to the recording medium.

Examples of the glycol ethers include alkylene glycol monoethers and alkylene glycol diethers.

Examples of the alkylene glycol monoethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

Examples of the alkylene glycol diethers include ethylene glycol dimethyl ether, ethylene glycol diethyl ether, ethylene glycol dibutyl ether, diethylene glycol dimethyl ether, diethylene glycol diethyl ether, diethylene glycol ethylmethyl ether, diethylene glycol dibutyl ether, triethylene glycol dimethyl ether, triethylene glycol diethyl ether, triethylene glycol dibutyl ether, triethylene glycol butylmethyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

The glycol ethers can be used singly, or two or more can be used mixed together. The glycol ethers can be suitably used because they provide less reduction in the surface tension of the ink even though they improve the penetrability and wettability of the ink to the recording medium.

When the glycol ethers are contained, their content can be, for example, 0.05% by mass or more and 6% by mass or less with respect to the total mass of the ink. Furthermore, to appropriately control wettability also in consideration of the precipitation of aggregates or the like, the content is preferably 0.2% by mass or more and 4% by mass or less.

Examples of the polyhydric alcohols (except the alkanediols) include ethylene glycol, propylene glycol, 1,3-propanediol, 1,3-butanediol, 1,3-pentanediol, 1,4-butanediol, 1,5-pentanediol, 1,6-hexanediol, 2,3-butanediol, 3-methyl-1,3-butanediol, 2-methyl-2,4-pentanediol, 3-methyl-1,5-pentanediol, diethylene glycol, triethylene glycol, tetraethylene glycol, dipropylene glycol, trimethylol propane, and glycerin. The polyhydric alcohols can be suitably used from the viewpoint of being capable of preventing drying and solidification of the ink on the nozzle face of the head to reduce clogging, faulty ejection, and the like. When the polyhydric alcohols are contained, their content can be, for example, 5% by mass or more and further 5% by mass or more and 30% by mass or less with respect to the total mass of the ink.

Examples of the nitrogen-containing heterocyclic compounds include N-methyl-2-pyrrolidone, N-ethyl-2-pyrrolidone, N-vinyl-2-pyrrolidone, 2-pyrrolidone, N-butyl-2-pyrrolidone, 5-methyl-2-pyrrolidone, and hydantoin. Examples of urea or urea derivatives include urea, ethylene urea, tetramethyl urea, and thiourea. These can be used singly, or two or more can be used mixed together. These compounds can be suitably used from the viewpoint of being capable of preventing drying and solidification of the ink on the nozzle face of head to reduce clogging, faulty ejection, and the like as in the polyhydric alcohols. When these compounds are contained, their content can be, for example, 0.5% by mass or more and 10% by mass or less and more preferably 1% by mass or more and 5% by mass or less with respect to the total mass of the ink.

The polyhydric alcohols, the nitrogen-containing heterocyclic compounds, urea, and the urea derivatives exhibit a function as a humectant. Among the above, by using glycerin and one or more selected from the group consisting of the polyhydric alcohols (except glycerin among the polyhydric alcohols described above), the nitrogen-containing heterocyclic compounds, urea, and the urea derivatives in combination, both long-term water evaporation and water evaporation quickly occurring on the wall face of an ink chamber can be effectively prevented. In this case, more preferred polyhydric alcohols are propylene glycol, dipropylene glycol, 1,3-butanediol, diethylene glycol, triethylene glycol, and trimethylol propane. Among the polyhydric alcohols, preferred are propylene glycol, dipropylene glycol, diethylene glycol, and 1,3-butanediol from the viewpoint of preventing precipitates. As the nitrogen-containing heterocyclic compounds, pyrrolidone derivatives and hydantoin are preferred, and 2-pyrrolidone and hydantoin are more preferred. As the urea derivatives, ethylene urea, tetramethyl urea, and thiourea are preferred.

When the ink of the present embodiment contains any one or more selected from 1,2-alkanediols having four to eight carbon atoms, 2-methyl-1,3-propanediol, 2,2-dimethyl-1,3-propanediol, 2-ethyl-1,3-hexanediol, and glycol ether, a humectant containing glycerin and one or more selected from the group consisting of the other polyhydric alcohols (except glycerin among the polyhydric alcohols described above), the nitrogen-containing heterocyclic compounds, urea, and the urea derivative in combination is desirably added from the viewpoint of preventing the precipitation of aggregates.

The total content of the organic solvent is preferably 0.1% by mass to 30% by mass, more preferably 1.0% by mass to 25% by mass, and even more preferably 5% by mass to 20% by mass with respect to the total amount of the ink composition.

### 1.4.5. Lactam-Based Compound

The ink composition of the present embodiment preferably contains a lactam-based compound.

By containing the lactam-based compound, the precipitation, crystallization, or the like of impurities or the like in the dispersion liquid of the azo-based pigment can be prevented while maintaining the saturation of the azo-based pigment, thereby showing a tendency that excellence is achieved in prevention of the occurrence of air-liquid interface foreign matter and excellence is also achieved in clogging recoverability, ejection stability, redissolvability, and the like.

In addition, the acetylene glycol-based surfactant A has relatively low dissolvability to water and undergoes phase separation with water when the ink is dried in nozzles or the like, which causes faulty ejection. By containing the lactam-based compound, there is a tendency that the phase separation of the acetylene glycol-based surfactant A during in drying is prevented.

In addition, in the air-liquid interface of the CISS tank liquid level, nozzles, or the like, some components of the ink such as the pigment dry and flocculate to become foreign matter, which may cause clogging. By the ink containing the lactam-based compound, there is a tendency that the flocculation of the pigment is prevented to increase redispersibility, which can prevent clogging. The CISS tank in particular causes the air-liquid interface on the liquid level, thus regarding the air-liquid interface foreign matter as a problem, and thus the present disclosure is particularly suitable.

Furthermore, when the ink that has adhered to the tank wall face dries, and the pigment or the like flocculates, the ink sticks to the wall face, making it difficult for the ink to run down, which may cause the worsening of the visibility of a liquid level. When the ink contains the lactam-based compound, such difficulty in the running down of the ink can be prevented, making the liquid level visibility better.

As the lactam-based compound, any lactam-based compound can be used without particular limitations. Among the nitrogen-containing heterocyclic compounds described above, those being the lactam-based compounds can also be used as the lactam-based compound.

Four to seven-membered lactam-based compounds are preferred, and five to seven-membered lactam-based compounds are preferred.

Examples thereof include 2-pyrrolidone, δ-lactam, 1-(2-hydroxyethyl)-2-pyrrolidone, and ε-caprolactam. Preferred are 1-(2-hydroxyethyl)-2-pyrrolidone and ε-caprolactam.

The content of the lactam-based compound is preferably 0.1% by mass to 7.0% by mass, more preferably 0.3% by mass to 6.0% by mass, and even more preferably 0.5% by mass to 5.5% by mass with respect to the total amount of the ink composition.

By the content of the lactam-based compound being the above lower limit or more, there is a tendency that excellence is achieved in prevention of the occurrence of air-liquid interface foreign matter and excellence is also achieved in clogging recoverability, ejection stability, redissolvability, and the like.

By the content of the lactam-based compound being the above upper limit or less, there is a tendency that the lactam-based compound can be prevented from precipitating and excellence is achieved in clogging recoverability.

### 1.4.6. Water

The ink of the present embodiment may contain water. The ink of the present embodiment is preferably an aqueous ink with water as a main solvent of the ink and with water as a component evaporating and dispersing by drying. The content of water of the aqueous ink is preferably 40% by mass or more and more preferably 50% by mass or more with respect to the total mass of the ink. The content of water of the aqueous ink is preferably 60% by mass to 99% by mass.

Examples of water include ones with ionic impurities removed to the utmost such as pure water such as ion exchanged water, ultrafiltered water, reverse osmosis water, or distilled water and ultrapure water. When water sterilized with UV irradiation or addition of hydrogen peroxide is used, the occurrence of mold and bacteria can be prevented when the ink is stored for a long term.

### 1.4.7. Others

The ink of the present embodiment, for the purpose of improving its performance, may contain wax particles (for example, polyolefin waxes, paraffin waxes, or the like), amphoteric ion compounds (for example, betaine-based compounds, amino acids, derivatives thereof, or the like), sugars (for example, glucose, mannose, fructose, ribose, xylose, arabinose, galactose, aldonic acid, sorbitol, maltose, cellobiose, lactose, sucrose, trehalose, maltotriose, reduced starch saccharides, or the like), sugar alcohols, hyaluronic acids, ureas, antiseptics and mold inhibitors (for example, sodium benzoate, sodium pentachlorophenol, sodium 2-pyridinethiol-1-oxide, sodium sorbate, sodium dehydroacetate, 1,2-benzothiazolin-3-one, or the like), pH adjusting agents (for example, potassium dihydrogen phosphate, disodium hydrogen phosphate, sodium hydroxide, lithium hydroxide, potassium hydroxide, ammonia, diethanolamine, triethanolamine, triisopropanolamine, potassium carbonate, sodium carbonate, sodium hydrogencarbonate, or the like), chelating agents (for example, ethylenediaminetetraacetic acid and salts thereof (disodium dihydrogen ethylenediaminetetraacetate or the like)), defoaming agents (SN WET 980 (manufactured by San Nopco Ltd.) or the like), or the like.

One aspect of the ink composition of the present embodiment is an ink composition for use in recording by a recording apparatus having an ink storage body, an ink supply section, and an ink jet head, wherein the ink storage body has an ink pouring port through which the ink composition is poured and a liquid level display section displaying an ink liquid level of the ink composition stored in the ink storage body, the ink jet head is supplied with the ink composition from the ink storage body via the ink supply section and ejects the ink composition to cause the ink composition to adhere to a recording medium, and the ink composition is a water-based, red-based ink containing an azo-based pigment, an acetylene glycol-based surfactant A with an HLB value of less than 10 and an acetylene glycol-based surfactant B with an HLB value of 10 or more.

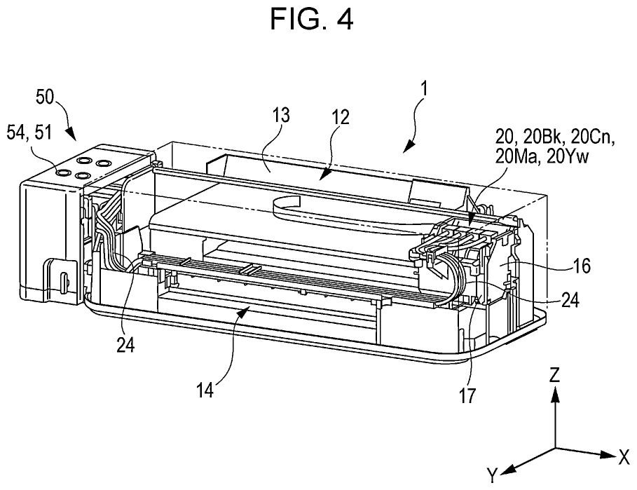

FIG. 4 is a perspective view schematically illustrating an example of the ink jet recording apparatus of the present embodiment. This ink jet recording apparatus 1 has an ink storage body 50 and an ink supply tube 24 supplying ink toward an ink jet head 17 from the ink storage body.

The ink supply tube 24 is an ink supply section. The ink supply section may circulate the ink inside and be able to supply the ink to the ink jet head from the ink storage body like the ink supply tube 24. The ink supply section 24 is a component constituting an ink supply path.

In a relay place between the ink storage body 50 and the ink jet head 17, a sub-tank 20 may be included, and the ink supplied via the ink supply tube 24 may be temporarily stored in the sub-tank 20 to be supplied to the ink jet head 17. Alternatively, the sub-tank 20 may not be included, and the ink may be directly supplied to the ink jet head 17 from the ink storage body 50 via the ink supply tube 24.

The ink jet head 17 ejects droplets of the ink composition (hereinafter also referred to simply as the “ink”) to record images on the recording medium.

Also included are a carriage 16 that mounts the sub-tank 20 and the ink jet head 17 and can reciprocate in the X-axis direction, a paper feed port 12 feeding the recording medium, a paper discharge port 14 discharging the recording medium, and a support 13 supporting the recording medium fed to the paper feed port 12.

The ink jet head 17 has a nozzle face (not shown) provided at a position facing the recording face of the recording medium and ejects the ink formed into a droplet shape from a plurality of nozzles (not shown) provided on the nozzle face to cause the ink to adhere to the recording face of the recording medium.

Examples of the method of ink jet recording include a method of applying a strong electric field to between acceleration electrodes placed at a nozzle and in front of the nozzle, continuously ejecting droplet-shaped ink from the nozzle, applying a printing information signal to deflecting electrodes while the ink droplets fly between the deflecting electrodes to perform recording, a method of ejecting ink droplets without deflecting them in correspondence with a printing information signal (the electrostatic attraction method), a method of applying pressure to ink liquid by a small-sized pump and mechanically vibrating a nozzle by a crystal oscillator or the like to compulsorily eject ink droplets, a method of simultaneously applying pressure and a printing information signal to the ink by a piezoelectric element to eject and record ink droplets (the piezo method), and a method of heating and foaming the ink by minute electrodes in accordance with a printing information signal to eject and record ink droplets (the thermal jet method).

The sub-tank 20 in FIG. 4 is provided with four sub-tanks 20Bk, 20Cn, 20Ma, and 20Yw for the respective colors as an example so as to correspond to the inks of the respective colors stored in the ink storage body 50. The ink jet head 17 also has four ink jet heads in correspondence with the inks of the respective colors.

The carriage 16 mounts the ink jet head 17 and the sub-tank 20 and reciprocates along the X-axis by a carriage moving mechanism (not shown) including a motor, a timing belt, and the like. Along with such movement of the carriage 16, the ink jet head 17 also reciprocates along the X-axis direction, and thus recording of images onto the recording medium in the X-axis direction is performed by ejection of the ink by the ink jet head 17 along with the movement of the carriage 16. The present embodiment describes the ink jet recording apparatus of what is called a serial head type, but this is not limiting. The ink container according to the present embodiment can also be used for the ink jet recording apparatus of what is called a line head type.

The paper discharge port 14 is provided on the front face of the ink jet recording apparatus 1. The paper feed port 12 is provided on the back side of the ink jet recording apparatus 1. By setting the recording medium at the paper feed port 12 and executing a recording operation, the recording medium is fed from the paper feed port 12, images or the like are recorded thereon inside, and the recording medium is discharged from paper discharge port 14. Transportation of the recording medium can be performed by a paper feed mechanism (not shown) for feeding paper in the Y-axis direction. Thus, recording of images onto the recording medium in the Y-axis direction can be performed by ejection of the ink by the ink jet head 17 along with the movement of the recording medium by the paper feed mechanism.

The ink jet recording apparatus 1 has a controller (not shown) controlling the operation of the entire ink jet recording apparatus 1. The controller may include, for example, a CPU, a ROM, and a RAM. The controller controls operations such as an operation to reciprocate the carriage 16, an operation to feed the recording medium, an operation to eject the ink from the ink jet head 17, and an operation to supply the ink from the ink storage body 50.

As to the ink storage body 50, FIG. 4 illustrates the entire ink storage body, in which it has a plurality of ink storage bodies separated for the respective inks and has the ink supply tube 24 and an ink pouring port 54 for each ink thereinside. The ink pouring port 54 is provided with a lid such as a cap, not shown, when the ink is not poured. The lid is openable and closable, and when the ink is poured, the lid is opened to pour the ink.

The ink storage body 50 may be a plurality of ink storage bodies by sectioning the inside by walls, or a plurality of ink storage bodies may be arranged side by side. Thus, the ink storage bodies for the respective inks are provided.

The positional relation among the ink storage bodies is not limited; for example, they may be arranged in the up-and-down direction (the Z direction) or arranged in the lateral direction (the X direction or the Y direction). When they are arranged in the up-and-down direction, the length of the entire ink storage body in the lateral direction is reduced, and thus the length of the ink jet recording apparatus in the lateral direction is reduced, reducing the footprint of the ink jet recording apparatus, which is preferred.

The positional relation among the ink pouring ports 54 is also not limited; they may be arranged in the up-and-down direction (the Z direction) or arranged in the lateral direction (the X direction or the Y direction). When the heights of the ink pouring ports 54 in the up-and-down direction are aligned, the positions of the ink pouring ports are easily confirmed during ink pouring, and the ink is easily poured, which is preferred.

The ink storage body 50 is provided with a liquid level display section, not shown. The liquid level display section is provided on, for example, the front face of the ink storage body 50 in the Y direction or the left side face thereof in the X direction.

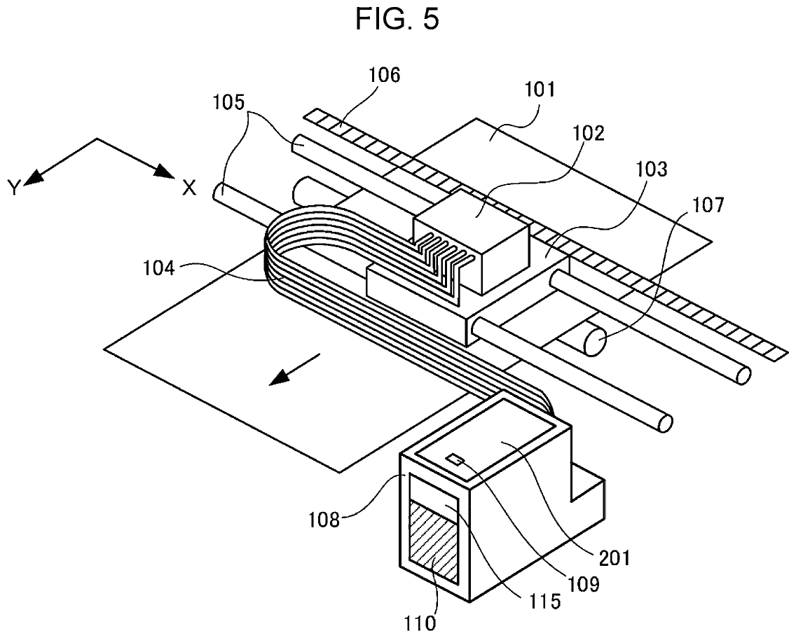

FIG. 5 is a perspective view schematically illustrating the surroundings of an ink jet head and an ink storage body of another example of the ink jet recording apparatus of the present embodiment. This example may be the same as the example in FIG. 4 except the following.

This ink jet head 102 has a nozzle face (not shown) provided at a position facing the recording face of the recording medium and ejects the ink formed into a droplet shape from a plurality of nozzles (not shown) provided on the nozzle face to cause the ink to adhere to the recording face of the recording medium, thus recording images on a recording medium 101.

The carriage 103 mounts the ink jet head 102 and can perform reciprocal movement moving it in the X-axis direction (a main scanning direction).

The carriage 103 is supported movably along a guide rail 105 disposed along the X direction and is fixed to an endless belt 106 moving in parallel to the guide rail 105. The endless belt 106 reciprocates through the drive force of a motor, thereby reciprocating the carriage 103 in the X direction.

A transportation roller 107 transports the recording medium 101 in a transportation direction Y.

An ink storage body 108 and the ink jet head 102 are connected to each other with an ink supply section 104 circulating the ink, and the ink is supplied to the ink jet head 102 from the ink storage body 108 via the ink supply section 104.

FIG. 5 illustrates one ink storage body 108, but the same number of ink storage bodies 108 as the number of ink compositions of the ink jet recording apparatus may be included. The same also applies to the ink jet head 102. When two or more ink jet heads are included, the ink jet heads may be integrated or separated from each other when viewed from the outside. The same also applies to the ink storage bodies.

The ink storage body 108 is provided with an ink pouring port 109 for pouring the ink into the ink storage body 108 from outside the ink jet recording apparatus. The ink pouring port 109 may be provided in an upper face 201 of the ink storage body 108 or the like.

When the ink jet recording apparatus is used for the first time, when the ink amount has decreased, or in other situations, the ink is poured from an ink bottle or the like. A user can open the ink pouring port 109 and pour the ink into the ink storage body 108. The ink storage body 108 is left in the ink jet recording apparatus, and it itself is not to be replaced. Formed on the side face of the ink storage body 108 is a liquid level display section 115 that enables visual checking of a liquid level, which is the upper face of an ink 110 stored in the ink storage body 108.

### 2. Method of Recording

A method of recording of the present embodiment is a method of recording performed using the recording apparatus of the present embodiment, the method including a supplying step of supplying an ink composition to the ink jet head from the ink storage body via the ink supply section and an adhering step of ejecting the ink composition from the ink jet head to cause the ink composition to adhere to a recording medium, wherein the ink storage body has an ink pouring port through which the ink composition is poured and a liquid level display section displaying an ink liquid level of the ink composition stored in the ink storage body, and the ink composition is a water-based, red-based ink containing an azo-based pigment, an acetylene glycol-based surfactant A with an HLB value of less than 10 and an acetylene glycol-based surfactant B with an HLB value of 10 or more.

The ink jet recording apparatus of the present embodiment has the ink storage body for supplying the ink composition to the ink jet head.

The aspect of supplying the ink composition to the ink jet head from the ink storage body is not particularly limited.

For example, the ink jet head and the ink storage body may communicate with each other via a communicating section (the ink supply section), and the ink composition may be supplied to the ink jet head from the ink storage body via the communicating section.

Specifically, the following aspect is possible.

One end of a liquid supply tube is connected to the ink storage body, and the other end thereof is connected to the ink jet head. The ink stored in the ink storage body is supplied to the ink jet head via the liquid supply tube.

The method of recording of the present embodiment includes the adhering step of ejecting the ink composition from the ink jet head to cause the ink composition to adhere to the recording medium.

The method of ink jetting is not particularly limited, and examples thereof include the charge deflection method, the continuous method, and the on-demand method (the piezo method and the bubble jet (registered trademark) method).

The method of recording of the present embodiment may further eject a cyan ink, a yellow ink, and a black ink from other ink jet heads to cause the inks to adhere to the recording medium in the adhering step.

A step of pouring the ink into the ink storage body may be included. The step is a step of opening the lid of the ink pouring port of the ink storage body, pouring the ink into the ink storage body from the ink pouring port, and refilling the ink into the ink storage body. For example, the ink stored in an ink bottle or the like may be poured to the ink pouring port from the ink bottle.

Upon completion of ink pouring, an ink liquid level of the ink composition is displayed in the liquid level display section, allowing the remaining amount of the ink composition to be checked.

### 2.1. Recording Medium

The constituent of the recording medium is not particularly limited, and examples thereof include resin materials such a polyurethane, polyethylene, polypropylene, polyester, polyamide, and acrylic resins, paper, glass, metal, ceramic, leather, wood, pottery, and fabric.

Examples of the constituent of the recording medium include fibers containing at least one of the above, various natural fibers, synthetic resins, and semi-synthetic fibers such as silk, wool, cotton, hemp, polyester, polyamide (nylon), acrylic, polyurethane, cellulose, linter, rayon, cupra, and acetate. As the recording medium, one or two or more in combination selected from the above constituents can be used. As the recording medium, one having a sheet shape or a three-dimensional shape such as a spherical or rectangular parallelepipedal shape may be used.

Examples of the recording medium include absorbent recording media having ink absorbency, low-absorbent recording media having low ink absorbency, and non-absorbent recording media absorbing no ink.

Examples of the absorbent recording media include recording media provided with an ink-absorbent ink reception layer on their surface and recording media the base itself of which itself has ink absorbency. Examples thereof include fabric, plain paper, and paper for exclusive use of ink jet.

Examples of the low-absorbent recording media include coated paper provided with a low ink-absorbent coated layer.

The non-absorbent recording media contain non-ink-absorbent materials such as glass, metal, and plastic, and examples thereof include recording media not provided with an ink-absorbent ink reception layer on their surface and recording media provided with a non-ink-absorbent layer on their surface.

### Examples

The following describes the present disclosure more specifically using examples and comparative examples. The present disclosure is not limited by the following examples at all.

### Materials of Ink Composition

Main materials of ink compositions used in the following examples and comparative examples are as follows.

### Pigment

Dispersion liquid A: a dispersion liquid containing PR 150 (azo pigment, Pigment Red 150)
Dispersion liquid B: a dispersion liquid containing PV 19 (quinacridone pigment, Pigment Violet 19)
Dispersion liquid C: a dispersion liquid containing PR 17 (azo pigment, Pigment Red 17)
Dispersion liquid D: a dispersion liquid containing PR 122 (quinacridone pigment, Pigment Red 122)

### Preparation of Pigment Dispersion Liquid

Pure water was added to 20% by mass of each pigment and 7% by mass of a sodium hydroxide neutralized product of a styrene-acrylic acid copolymer (acid value: 175 mgKOH/g. molecular weight: 10,000) to make the entire 100% by mass, and they were stirred and mixed together to obtain a mixture. This mixture was put into a wet sand mill filled with zirconia beads with a diameter of 0.3 mm and was subjected to dispersion processing for 6 hours. Subsequently, the zirconia beads were removed with a separator, and the liquid was filtered with a cellulose acetate filter with a pore size of 3.0 μm to produce a pigment dispersion liquid. Note that the styrene-acrylic acid copolymer is a water-soluble polymer generally used as a dispersant for pigments. The volume average particle size D50 measured with a particle size distribution meter was 100 nm each.

### Lactam Compound

HEP: 1-(2-Hydroxyethyl)-2-pyrrolidone
ε-Caprolactam
Penetrant
1,2-Hexanediol
Organic Solvent
Gly: Glycerin
TEG: Triethylene glycol

### Surfactant

Olfine E1010 (HLB: 13 to 14, acetylene glycol-based surfactant, manufactured by Nissin Chemical Co., Ltd.)
Olfine EXP. 4200 (HLB: 10 to 12, acetylene glycol-based surfactant, manufactured by Nissin Chemical Co., Ltd.)
Surfynol 104 (HLB: 4, manufactured by AirProducts and Chemicals. Inc.)
Surfynol SE-F (HLB: 6, manufactured by AirProducts and Chemicals. Inc.)

### Resin

Superflex 420 (polyurethane water dispersion, manufactured by DKS Co. Ltd.)

### Alkali

TEA: Triethanolamine

### Preparation of Ink Composition

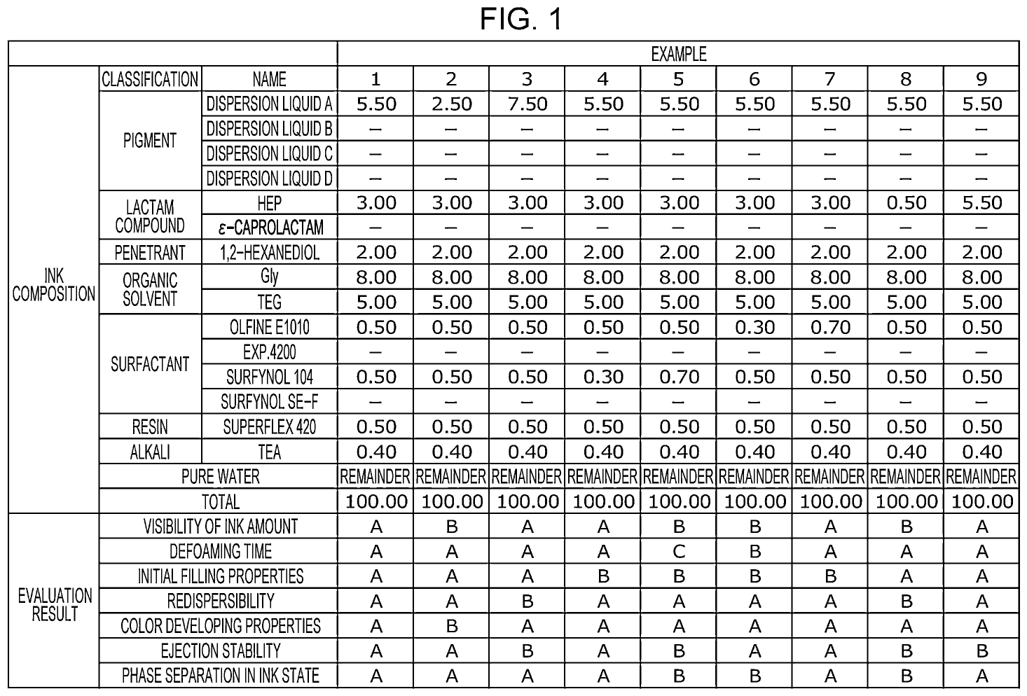

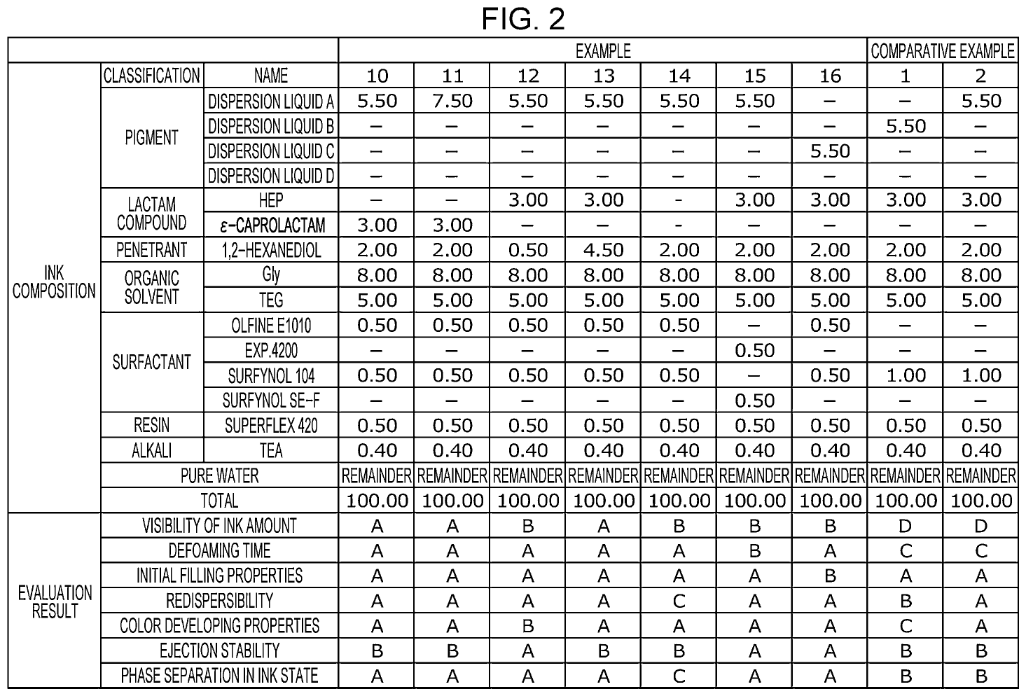

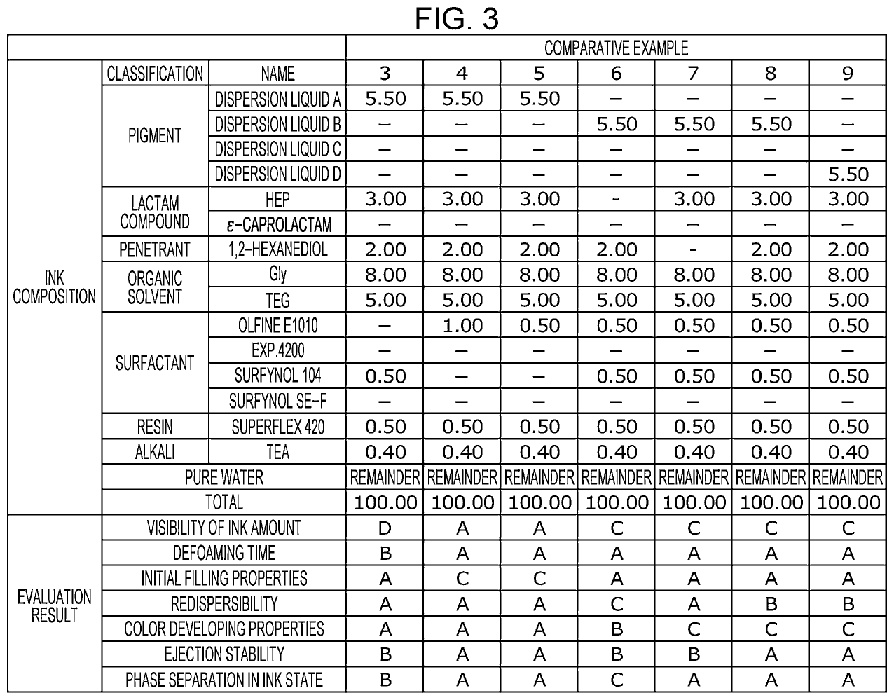

The pigment dispersion liquids and the materials were mixed together with the compositions shown in FIG. 1 to FIG. 3 below and were sufficiently stirred to obtain ink compositions. In FIG. 1 to FIG. 3, the unit of the values is % by mass, with the total being 100.0% by mass. The pigment is & by mass of the pigment in the ink.

All the inks were red-based inks that can be used as magenta inks. Although not shown below, they were inks that can perform recording as a set with a yellow ink, a black ink, and a cyan ink separately prepared. In addition, with a magenta ink separately prepared and also used as a set, the inks of the present embodiment could also be used as red inks.

The following evaluations were made for the ink compositions.

### Evaluations

### Visibility of Ink Amount in Tank

A modified machine of an ink jet recording apparatus (EW-M873T manufactured by Seiko Epson Corporation) was prepared. A CISS tank was included, and the material of the inner wall of the liquid level display section of the CISS tank was polypropylene. An ink in an amount of 150 ml was poured into the main tank (the CISS tank). Subsequently, the ink stored in the main tank was extracted, and 75 ml of an ink was poured again.

After a lapse of 3 minutes after pouring the ink again, for the part corresponding to the difference between 150 mL and 75 mL of the main tank of the liquid level display section, the adhesion state of the ink, the state of coloring, and the ink amount (the height of the liquid level) were visually observed, and the visibility of an ink amount was evaluated in accordance with the criteria shown below

“A” and “B” were evaluated to be a permissible level, whereas “C” and “D” were evaluated to be an impermissible level.

### Criteria

A: Neither adhesion nor coloring of the ink was observed, and the height of the liquid level in the liquid level display section was able to be visually checked at a distance of 30 cm.
B: A small amount of the ink adhered or the air-liquid interface was thin, but the ink remaining amount in the liquid level display section was able to be checked at a distance of 30 cm.
C: A small amount of the ink adhered, but the air-liquid interface was thin, and it was difficult to visually check the height of the liquid level in the liquid level display section at a distance of 30 cm.
D: A large amount of the ink adhered, and it was difficult to visually check the height of the liquid level in the liquid level display section at a distance of 30 cm.

### Defoaming Time

The ink composition in an amount of 20 g was weighed and put into a 100 g screw bottle. The screw bottle was shaken vertically 20 times, and the time for a foamless area with a diameter of 1 cm to be formed when the liquid level was viewed from above the screw bottle was defined as a defoaming time, which was evaluated in accordance with the criteria shown below.

### Criteria

A: Defoaming time<5 minutes
B: 5 minutes≤ defoaming time<30 minutes
C: 30 minutes≤ defoaming time

### Initial Filling Properties

The ink composition after being filtered and deaerated was poured into the CISS tank of the ink jet recording apparatus, which was an unused printer, and was left until foam during ink pouring settled down, and then initial filling was performed to the ink jet head.

After initial filling, nozzle check printing was performed, it was visually checked for kinky printing or non-ejection, and evaluation was performed in accordance with the criteria shown below.

### Criteria

A: Neither kinky printing nor non-ejection occurred.
B: Kinky printing or non-ejection occurred.

Note that kinky printing means a deviation of an ink impact position. A deviation of the impact position with 50% or more of the distance between adjacent nozzles at a distance of 0.5 mm in an ejection direction from the nozzles was regarded as kinky printing.

### Redispersibility

When a new ink composition was poured more to the ink composition once dried on the nozzle face or the like, it was checked whether the new ink composition was redissolved.

The ink composition was placed dropwise (2 μL×5) onto a glass slide and was dried at 60° C. for 1 day.

The ink composition after drying was charged into water, and the glass slide was left at rest for 3 minutes, was then turned upside down five times, and was taken out, and ink remaining on glass and redissolvability to water were evaluated in accordance with the criteria shown below.

### Criteria

A: All the ink droplets were redissolved.
B: All the ink droplets were redissolved, but there were residues of the dried ink composition on the glass slide.
C: The ink droplets were not redissolved and remained as solids on the glass slide.

### Printing

With an ink droplet mass of 12.5 ng/dot, and with a basic resolution of 600×600 dpi, the dot density was adjusted (the number of ink droplets per pixel was adjusted) such that the ink adhesion amount in a solid pattern was 5 mg/inch², and printing was performed on Xerox P paper (plain paper).

### Color Developing Properties

A monochromatic test pattern was recorded on the printing conditions described above. The test pattern was measured with a colorimeter (colorimeter: Xrite i1 (manufactured by Xrite)) to evaluate an OD value, and color developing properties were evaluated in accordance with the criteria shown below.

### Criteria

A: OD value≥0.85
B: 0.85>OD value≥0.75
C: 0.75>OD value

### Ejection Stability

Printing was performed continuously for 1 hour on the above printing condition, and after printing, it was visually checked for kinky printing or omissions, and ejection stability was evaluated in accordance with the criteria shown below.
A: Neither kinky printing nor omissions occurred.
B: Kinky printing or omissions occurred.

### Phase Separation in Ink State

The ink composition was put into a glass screw bottle and was left at rest in a 60° C. environment for 24 hours. After it was taken out of the 60° C. environment, whether the surfactant was separated and floated on the ink liquid level was visually checked, and the phase separation in an ink state was evaluated in accordance with the criteria shown below.
A: No separation of the surfactant occurred.
B: The surfactant was separated or floated.
C: The surfactant was completely separated to be a double layer.

As shown in FIG. 1 to FIG. 3, the examples using the recording apparatus of the present embodiment were rated as A or B in the visibility of an in amount and initial filling properties and were excellent in the visibility of an ink amount and initial filling properties.

On the other hand, Comparative Examples 1 and 6 to 9, which do not contain the azo-based pigment, were poor in the visibility of an ink amount. Comparative Examples 2 and 3, which do not contain the acetylene glycol-based surfactant B with an HLB value of 10 or more, were poor in the visibility of an ink amount. Furthermore, Comparative Examples 4 and 5, which do not contain the acetylene glycol-based surfactant A with an HLB value of less than 10, were poor in initial filling properties.

What is claimed is:

1. A recording apparatus comprising:
an ink storage body;
an ink supply section;
an ink jet head; and
an ink composition, wherein
the ink storage body has an ink pouring port through which the ink composition is poured and a liquid level display section displaying an ink liquid level of the ink composition stored in the ink storage body,
the ink jet head is supplied with the ink composition from the ink storage body via the ink supply section and ejects the ink composition to cause the ink composition to adhere to a recording medium, and
the ink composition is a water-based, red-based ink containing an azo-based pigment, an acetylene glycol-based surfactant A with an HLB value of less than 10 and an acetylene glycol-based surfactant B with an HLB value of 10 or more.

2. The recording apparatus according to claim 1, wherein
a content of the acetylene glycol-based surfactant A is 0.1% by mass to 0.8% by mass with respect to a total amount of the ink composition, and
a content of the acetylene glycol-based surfactant B is 0.1% by mass to 0.8% by mass with respect to the total amount of the ink composition.

3. The recording apparatus according to claim 1, wherein a content of the azo-based pigment is 1.0% by mass to 8.0% by mass with respect to a total amount of the ink composition.

4. The recording apparatus according to claim 1, wherein a content of a lactam-based compound is 0.1% by mass to 7.0% by mass with respect to a total amount of the ink composition.

5. The recording apparatus according to claim 1, wherein the red-based ink is a magenta ink.

6. The recording apparatus according to claim 1, wherein
the ink composition contains 1,2-alkanediols having four to eight carbon atoms, and
a content of the 1,2-alkanediols is 1.0% by mass to 4.0% by mass with respect to a total amount of the ink composition.

7. The recording apparatus according to claim 1, further comprising:
a cyan ink, a yellow ink, and a black ink; and
an ink jet head C ejecting the cyan ink, an ink jet head Y ejecting the yellow ink, and an ink jet head B ejecting the black ink.

8. The recording apparatus according to claim 1, wherein the azo-based pigment is at least one selected from the group consisting of C.I. Pigment Red 150, C.I. Pigment Red 269, and C.I. Pigment Red 17.

9. A method of recording performed using a recording apparatus having an ink storage body, an ink supply section, and an ink jet head, the method comprising:
a supplying step of supplying an ink composition to the ink jet head from the ink storage body via the ink supply section; and
an adhering step of ejecting the ink composition from the ink jet head to cause the ink composition to adhere to a recording medium, wherein
the ink storage body has an ink pouring port through which the ink composition is poured and a liquid level display section displaying an ink liquid level of the ink composition stored in the ink storage body, and
the ink composition is a water-based, red-based ink containing an azo-based pigment, an acetylene glycol-based surfactant A with an HLB value of less than 10 and an acetylene glycol-based surfactant B with an HLB value of 10 or more.

10. An ink composition for use in recording by a recording apparatus having an ink storage body, an ink supply section, and an ink jet head, wherein
the ink storage body has an ink pouring port through which the ink composition is poured and a liquid level display section displaying an ink liquid level of the ink composition stored in the ink storage body,
the ink jet head is supplied with the ink composition from the ink storage body via the ink supply section and ejects the ink composition to cause the ink composition to adhere to a recording medium, and
the ink composition is a water-based, red-based ink containing an azo-based pigment, an acetylene glycol-based surfactant A with an HLB value of less than 10 and an acetylene glycol-based surfactant B with an HLB value of 10 or more.
